(19) United States
(12) Patent Application Publication
(10) Pub. No.: US 2020/0305339 A1
(43) Pub. Date: Oct. 1, 2020

(54) PLANTING MACHINE

(71) Applicant: AGRIPLANT NV, LANGEMARK-POELKAPELLE (BE)

(72) Inventor: Bart PARREIN, Langemark (BE)

(73) Assignee: AGRIPLANT NV

(21) Appl. No.: 16/833,361

(22) Filed: Mar. 27, 2020

(30) Foreign Application Priority Data
Mar. 29, 2019 (BE) BE-2019/5199

(51) Int. Cl. A01C 5/06; A01C 11/02; A01B 79/00; H04W 4/029

(52) U.S. Cl. CPC A01C 5/06; H04W 4/029; A01B 79/005; A01C 11/02

(57) ABSTRACT

A planting machine (1) for plants (2), such as seedlings (2), said planting machine (1) being provided for arranging plants (2) in a field (5) in such a way that, after being arranged in the field (5), the plants (2) comprise an above-ground portion (3) that extends above ground and an underground portion (4) that extends underground, said planting machine (1) comprising a detection system for detecting the plants (2) after the plants (2) have been arranged in the field, said detection system comprising at least one measuring instrument (6) for detecting said above-ground portions (3) of the plants, and a method for mapping the position of plants (2) in a field (5).

This invention relates to a planting machine for arranging plants, such as seedlings, in a field in such a way that, after being arranged in the field, the plants comprise an above-ground portion that extends above ground and an underground portion that extends underground, said planting machine comprising a detection system for detecting the plants after the plants have been arranged in the field, said detection system comprising at least one measuring instrument for detecting said above-ground portions of the plants, and the planting machine comprising or being capable of coupling to an electronic device, such as a central processing unit, the detection system being provided for sending signals to the electronic device according to the detection of said above-ground portions of the plants and the electronic device being provided for processing said signals.

This invention also relates to a method for mapping the position of plants in a field.

Planting machines with which plants are arranged in a field in such a way that one portion of the plants extends underground and one portion of the plants extends above ground are used to arrange, for example, seedlings, plant cuttings, small trees, shrub plants, bulbs that have already in part sprouted, etc. The arrangement of plants in a field can also be referred to using the term “planting of plants in a field” or “transplanting of plants in a field.” A planting machine can also be referred to using the term “transplanting machine” or “replanting machine.” When arranging the plants in the field, there is already a portion of the plants that is provided to extend primarily above ground, and when arranging said plants in the field, it will be ensured that said portion therefore primarily extends above ground. Seedlings are frequently used when cultivating crops that have relatively expensive seeds, such as cauliflowers, broccoli, tomatoes, celery, onions, lettuce, leek, etc. Seedlings are usually obtained by arranging a seed in a clod and allowing said seed to germinate into a seedling. The clod with the seedling is then planted in the field by the planting machine, and the plants are often harvested individually (one by one) after their growth period. The planting machine usually arranges said seedlings in such a way that the clod primarily extends below the ground surface of the field. In this case, the above-ground portion is the portion of the seedling that extends above the ground surface of the field, and the underground portion of the seedling is the portion of the seedling that extends below the ground surface of the field. However, said seedlings can also be arranged in the field by the planting machine in such a way that (a portion of) the clod extends above the ground surface of the field. The above-ground portion of the seedling is, in this case, the portion of the seedling that extends above the clod. The seedlings can also be obtained by arranging the seeds in a seedbed, in a field or in water (hydroponics) and allowing said seeds to germinate and then harvesting the seedling in such a way that a virtually bare root is present. Said seedling is then arranged in the field with the aid of the planting machine in such a way that the root primarily extends below the ground surface of the field, that is to say, extends underground.

Between the arrangement of the plants in the field and the harvesting of the fully grown plants, various intermediate treatments, such as hoeing between rows, hoeing within rows, fertilizing, irrigating, spraying the plants with chemical or biological pesticides, spraying the portion of the field between the plants with, for example, pesticides, etc., are often necessary. Said intermediate treatments can be carried out manually and/or using agricultural machinery. To safeguard against excessive use of, for example, fertilizers, sprays, pesticides, water, etc., more and more precision agriculture is being done. For example, it is no longer the case that the entire field is fertilized or irrigated during fertilization or irrigation. Instead, fertilization or irrigation is only done at the level of the plants themselves. If one desires to automate as many of the aforementioned treatments as possible and/or if one desires to automate harvesting, this means that it is necessary to know precisely where the plants are located in the field to avoid damaging the crops during, for example, hoeing and to prevent the crops from not being fertilized and/or not being irrigated, from being sprayed/not being sprayed and/or not being harvested.

The planting machines used are increasingly better at arranging the plants in the desired place in the field. This already provides a clear overview of the distribution of the plants in the field. Sensors with which the plants are detected when said plants are still in the planting machine are also already used so that it is possible to estimate where the plants are arranged in the field by the planting machine. However, while the plants are being arranged in the field (the planting itself), the plant may be shifted somewhat. Thus, the plants are, for example, arranged in a furrow that is later closed again. While the plants are being arranged in the furrow and/or while the furrow is being closed again, the plants can be shifted somewhat such that it is no longer precisely known where in the field the plant is located. As a result of this, the planting distance between the various plants is not the same everywhere and/or the plants in the same row are not on the same line. It may also be the case that diseased plants or poorly developed plants are arranged in the field during planting. For example, when seedlings are formed, not all the seeds that are arranged in a clod germinate (equally well) such that empty clods or less well-developed seedlings may be arranged in the field by the planting machine. As a result of this, there is not always a (good) plant present in the place where a (good) plant is expected. If one desires to do precision agriculture and/or desires to automate more, this means that one has insufficient information about the position of the (good) plants in the field. This problem is solved by, for example, flying a drone with a camera above the field to map the position of the plants. However, this means an extra action is necessary. There is also a risk that not all plants are mapped equally well and/or that weeds are mapped. With the aid of a drone, it is also difficult to determine where the diseased and/or less developed plants are located. WO 2017/181127 A1 describes a planting machine that is capable of arranging plants in a field that are already marked with a signaling material, such as a fluorescent element, or a planting machine that is capable of applying such a signaling material to the plants while arranging the plants in the field and does so with the aid of, for example, a detection system, with which the plant is detected and with which it is then determined when the signaling material needs to be applied. The result is that plants that are arranged with the aid of said planting machine all comprise a signaling material. By then providing the machines that carry out the additional treatments and/or harvesting with a detection system that recognizes the signaling material, it is possible to do precision agriculture. However, the disadvantage here is that the machines of the latter kind each need to be provided with a detection system of the latter kind and that a signaling material is necessary for each plant, which, of course, results in a higher cost.

An object of the invention is therefore to simplify and optimize the mapping of the position of plants in the field.

This object is achieved by providing a planting machine as presented in the first paragraph of this description, the electronic device being provided for mapping the position of the plants in the field, and this at least based on the signals coming from the detection system.

In this case, the planting machine itself has a detection system that is capable of detecting the above-ground portion of a plant after said plant has been arranged in the field by the planting machine, that is to say, after said plant has taken up its fixed position in the field. This means that while the planting machine is being used, that is to say, while the various plants are being arranged in the field, the plants will already be detected in the field after the plants have been arranged in the field and therefore after the position of the plants in the field has been determined. With the aid of said detection system and said electronic device, the plants are precisely mapped in the field while the planting machine is used, as a result of which extra actions for mapping the plants afterward become unnecessary. After a field has been planted with the aid of said planting machine, the location of the plants in the field is therefore immediately known. In this case, said detection system and said electronic device are therefore used to map the position of the plants in a field directly during planting.

The position of the plants in the field is mapped according to the detection of said above-ground portions of the plants by said detection system. The detection system detects the above-ground portion. This means that only the plants that also comprise an above-ground portion will be detected. If, for example, seedlings with a clod are planted, there is no detection of the clods in which the seeds have not germinated or have not fully germinated to have an above-ground portion, which is why said clods are also not mapped. This makes it possible to precisely know where the plants are located in the field and prevents, for example, excess fertilization, irrigation, spraying and/or too little hoeing or spraying. In a specific embodiment, a detection system can be provided that can determine whether a plant arranged in the field is sufficiently developed and/or diseased. Thus, for example, a detection system can be provided that can distinguish a diseased or poorly developed above-ground portion from a well-developed above-ground portion. Said detection system is then used here to map the position of the good plants in a field and, possibly, to map the diseased/less developed plants in the field. This makes it possible to prevent plants that will not grow well from being fertilized, irrigated, etc., or it is possible to additionally fertilize, irrigate, spray, etc. the diseased or less developed plants. Thus, for example, it is possible to detect whether certain plants are being affected by molds, harmful bacteria, etc. to effectively treat said plants against said molds, bacteria, etc.

In this case, the detection system is provided for sending signals to the electronic device according to the detection of said above-ground portions of the plants that are arranged in the field by the planting machine. The electronic device can, for example, comprise a central processing unit and/or a controller such as a chip and is capable of processing signals coming from the detection system. Thus, for example, the electronic device can be capable of mapping the position of the (good) plants in the field based on said signals. Said information about the plants in the field can then be passed on to/read into other machines, such as machines for hoeing weeds, machines for fertilization, machines for irrigation and/or harvesting machines, machines for spraying, such that any subsequent treatments and/or harvesting can be automated and be carried out as perfectly as possible. The planting machine itself preferably comprises said electronic device. This ensures that the signals are always correctly passed on to the electronic device. Furthermore, in a specific embodiment, the planting machine itself is capable of wirelessly sending the information coming from the electronic device. If the planting machine itself does not have said electronic device, the planting machine can be coupled to such an electronic device. Thus, for example, the detection system can be provided to wirelessly pass on said signals to a central electronic device such as a central computer system. The signals are preferably sent from the detection system in real time. Said signals can therefore also be used to, for example, control/adjust the planting machine. If it appears that the plants are not arranged in the field in the desired manner, it is possible to adjust the planting machine. For example, it is desired that the planting distance in one raw is virtually constant. The position of the rows of plants with respect to each other can also be of importance such that it may be desired for the plants to extend in consecutive rows of plants along lines that are virtually perpendicular to the rows of plants or it is desired for the plants of consecutive rows of plants to be somewhat shifted with respect to each other as seen in the planting direction. Thus, for example, it is possible to control/adjust the speed of the planting machine and/or to control/adjust components of the planting machine that contribute to arranging the plants in the field.

Because the detection system is provided for detecting the plants after the plants have been arranged in the field by the planting machine while the planting machine is used to arrange the plants in the field, it is then possible to immediately know where the plants are located in the field with the aid of the electronic device. After the planting machine has arranged all the plants in the field, the location of the plants is directly known, making additional actions for mapping the plants unnecessary and eliminating the need for other machines, such as drones, or for agricultural vehicles for subsequent treatment that comprise detection systems.

The planting machine can be provided to arrange plants in a field one by one and row by row. The planting machine can also be provided to arrange a plurality of rows of plants in the field at the same time. In this case, the detection system preferably comprises at least one measuring instrument for each row; however, it is also possible for one measuring instrument to be capable of detecting plants in a plurality of rows.

The at least one measuring instrument preferably comprises a sensor for measuring one or more biophysical properties of said above-ground portions of the plants.

Biophysical properties include, inter alia, the color, size, volume, compaction, number of leaves, reflection, chlorophyll content, disease symptoms, etc. of the above-ground portion. In this manner, it is easy to determine where the good plants, that is, the plants that will probably grow into a plant suitable for harvesting, are located in the field and/or it is easy to determine which plants require additional treatments. For example, it is possible to determine which plants need to be sprayed with pesticides, as a result of which it is possible to drastically reduce the use of pesticides. It is possible to use optical sensors, temperature sensors, distance sensors, etc.

The detection system can comprise one or more sensors for measuring one or more biophysical properties. The detection system can also comprise one or more sensors that only detect the position of the above-ground portion. For example, it is possible to use optical sensors, temperature sensors, distance sensors, etc.

In a preferred embodiment, the planting machine comprises a GNSS system for correlating the signals coming from the detection system with the GNSS location. GNSS stands for “Global Navigation Satellite System.” GPS (Global Positioning System), Glonass, Galileo, and Beidou are part of the GNSS. In this manner, it is very easy to determine where the plants are located in the field and therefore very easy to map the position of the plants in the field. Said GNSS system can, for example, be capable of detecting the position of the planting machine itself. However, the GNSS system is preferably capable of detecting the position of the detection system or the position of the various components of the detection system, such as the position of a measuring instrument of the aforementioned type. In this manner, it is very easy to determine where the detected above-ground portions are located in the field because it is still possible to determine the precise location of a measuring instrument of the aforementioned type. More specifically, the planting machine comprises a DGPS (differential GPS) system or an RTK-GPS (Real Time Kinetic-GPS) system.

More preferably, the GNSS system is provided for sending signals to the electronic device and the electronic device is provided for mapping the position of the plants in the field based on the signals coming from the GNSS system and the signals coming from the detection system. In this case, it is possible to get a very precise representation of the position of the plants in the field such that any subsequent treatments and/or harvesting can take place with very high precision with the aid of automated machines without the need for said automated machines to have plant detection systems.

It is also more preferable for the planting machine to comprise a planting device for physically arranging the plants in the field and for the electronic device to be provided for contributing to the control of the planting device. The electronic device obtains the signals from the detection system and possibly the signals from the GNSS system if present. Based on this, it is possible to estimate whether the plants are still being arranged in the field well while the planting machine is being used. Based on said signals, it is thus possible to obtain information about the planting distance as well as information about the straightness of the position of the plants in a row. Based on said information, it is possible to control the planting device in an ideal manner. Additionally or alternatively, the electronic device can be provided for adjusting the travel speed of the planting machine.

It is also more preferable for the planting machine to comprise a treatment system for treating the plants that are arranged in the field by the planting machine and for the electronic device to be provided for controlling this treatment system, and this at least based on the signals coming from the detection system. This treatment system is preferably provided for spraying and/or irrigating the plants after said plants have been arranged in the field. The detection system is preferably capable of detecting certain disease symptoms of the plant so that the diseased plants can be treated by the treatment system. This means that the planting machine will not only plant the plants but will also, if necessary, treat them, making fewer subsequent treatments necessary. Thus, for example, the detection system can be capable of detecting molds, harmful bacteria, etc. so that it is then possible to spray the plants affected by molds, bacteria, etc. with pesticides with the aid of the treatment system. In an alternative embodiment, the planting machine comprises a treatment system for treating the plants that are arranged in the field by the planting machine and the planting machine comprises an additional detection system that is provided for detecting the plants prior to or while arranging the plants in the field, the treatment system being controlled based on the signals coming from said additional detection system.

The at least one measuring instrument preferably comprises an optical sensor such as a camera. Said one measuring instrument is provided for detecting the above-ground portion of a plant of the aforementioned type that has been arranged in the field by the planting machine. Because said above-ground portion extends above ground, said above-ground portion is easily visible, and an optical sensor is very suitable for detecting said above-ground portion.

Said optical sensor can, for example, be provided for detecting the position of a central part of said above-ground portions. In this manner, it is possible to simply map the central position of each plant, making it possible to better ensure that the fertilizers, water, etc. do not end up next to the plant during fertilization, irrigation, etc.

Said optical sensor can also (additionally) be provided for detecting the height of said above-ground portions. This makes it possible to determine the position of the good plants in the field. For example, it is possible to set a certain minimum height so that only the plants that have a certain height are mapped. Said optical sensor can also (additionally) be provided for detecting the color of the above-ground portion, the number of leaves of the above-ground portion, the degree of branching of the above-ground portion, the chlorophyll content, the reflection, disease symptoms, etc.

In a very preferred embodiment, the planting machine is provided for moving in a direction of travel while arranging the plants in the field and the planting machine comprises a planting device that is provided for physically arranging the plants in the field, the measuring instrument extending behind the planting device as seen in the direction of travel. More preferably, the measuring instrument extends a certain distance from the planting device as seen in the direction of travel. This means that the measuring instrument only enters the vicinity of a plant after said plant has been arranged in the field by the planting machine. This embodiment of the planting machine allows the measuring instrument to be very capable of detecting said above-ground portion of a plant after said plant has been arranged in the field by the planting device. Thus, for example, the measuring instrument can be attached to a rear portion of the planting machine, such as the rear of the chassis of the planting machine. The planting device can thus extend more centrally in the planting machine while the measuring instrument is located at the rear of the planting machine. If the measuring instrument comprises an optical sensor, said optical sensor can be attached, for example, to the rear of the chassis of the planting machine such that there is a lot of light exposure at the level of the optical sensor. Additional lighting can optionally be provided such that it is always possible to easily detect the above-ground portion of the plants.

More preferably, the planting machine comprises one or more furrow openers for towing one or more furrows, and the planting device is provided for arranging plants in the one or more furrows, and the planting machine comprises one or more furrow closers for closing the one or more furrows again after the plants have been arranged in the one or more furrows, and the measuring instrument extends behind the one or more furrow closers as seen in the direction of travel. More preferably, the measuring instrument extends a certain distance from the one or more furrow closers as seen in the direction of travel. This means that the measuring instrument only enters the vicinity of a plant after the one or more furrows has already been closed such that there is less of a risk of the measuring instrument also detecting the underground portion of the plant and thus sending false signals, for example, to the aforementioned electronic device. If the planting machine is provided to arrange plants in a plurality of furrows, it is possible to provide a plurality of measuring instruments that extend behind the respective furrow closers as seen in the direction of travel.

The detection system preferably comprises at least two measuring instruments of the aforementioned type for detecting said above-ground portions of the plants. With the aid of two or more measuring instruments, that is, for example, using two or more sensors, it is possible to get a very good overview of the position of the plants in the field that are arranged using the planting machine. Possible margins of error can be handled much better here, as a result of which said planting machine can be used to do precision agriculture much better for subsequent treatments and/or for harvesting.

More preferably, the planting machine is provided for moving in a direction of travel while arranging the plants in the field, and said at least two measuring instruments extend at a distance from each other as seen in the direction of said direction of travel. In this manner, it is possible to detect the above-ground portion of a plant that is arranged in the field at the level of two different places of the planting machine, as a result of which it is possible to get a better overview of the position of the plants in the field that are arranged using the planting machine.

In a preferred embodiment, the planting machine comprises a detection system for detecting properties of the field. Said detection system can be an additional detection system or it can also be the same detection system as described above, the detection system then carrying out two functions, namely detecting the above-ground portion of a plant of the aforementioned type and detecting properties of the field. More preferably, said detection system for detecting properties of the field is then provided for passing on signals to the electronic device, if present, according to the detection of the properties of the field, and the electronic device is provided for processing said signals. Said detection system can, for example, detect the moisture, the soil type, the pH value of the soil, the electroconductivity of the soil, the humus content of the soil, etc. Based on this, the electronic device can then be provided to, for example, adjust the travel speed of the planting machine and/or, for example, control the various components of the planting machine. For example, if the planting machine comprises a furrow opener, it is possible, for example, to adjust the height/incline of said furrow opener as a function of the properties of the field. While the plants are being arranged in the field, it is possible to press the soil more or less, for example by controlling the furrow closer in the desired manner, to plant deeper or shallower, to change the planting distance, etc. In an alternative embodiment, it can be provided that the properties of the field are determined and that this information is already read in/input into the planting machine before the planting machine is used in order to control the manner of planting.

In a specific embodiment, the planting machine comprises a detection system for detecting the plants prior to or while arranging the plants in the field. Said detection system is preferably a separate detection system that is separate from the first detection system mentioned. This means that a plant is detected at two different times: once before the plant has taken its final position in the field and once after the plant has taken its final position in the field. If the planting machine comprises an electronic device of the aforementioned type, the detection system for detecting the plants prior to or while arranging the plants in the field is then preferably provided for sending signals to said electronic device according to the detected plant. All the signals can then be correlated such that a very accurate overview of the position of the plants in the field can be obtained. With the aid of said latter detection system, it is also possible to easily check whether the planting is being carried out properly and, if necessary, to adjust the planting machine. Said latter detection system can also be capable of detecting disease symptoms of plants and be provided for controlling a treatment system of the aforementioned type if present.

In another specific embodiment, the planting machine comprises a detection system for detecting the underground portion of the plants. Said detection system is preferably a separate detection system that is separate from the first detection system mentioned.

Said invention also relates to a method for mapping the position of plants in a field, the plants, such as seedlings, being arranged in the field with the aid of a planting machine as described above, and while the plants are being arranged in the field, the position of the plants in the field is mapped according to the detection of said above-ground portions of the plants by the respective detection system. This is a simple and fast way to map plants in a field. The at least one measuring instrument of said planting machine preferably comprises a sensor for measuring one or more biophysical properties of said above-ground portions of the plants.

The present invention will now be explained in greater detail with reference to the following detailed description of a preferable embodiment of a planting machine and a method according to the present invention. The purpose of this description is exclusively to provide illustrative examples and to specify further advantages and special features and can thus by no means be interpreted as a limitation of the scope of the invention or of the patent rights claimed in the claims.

In this detailed description, reference signs are used to refer to the enclosed drawings, in which

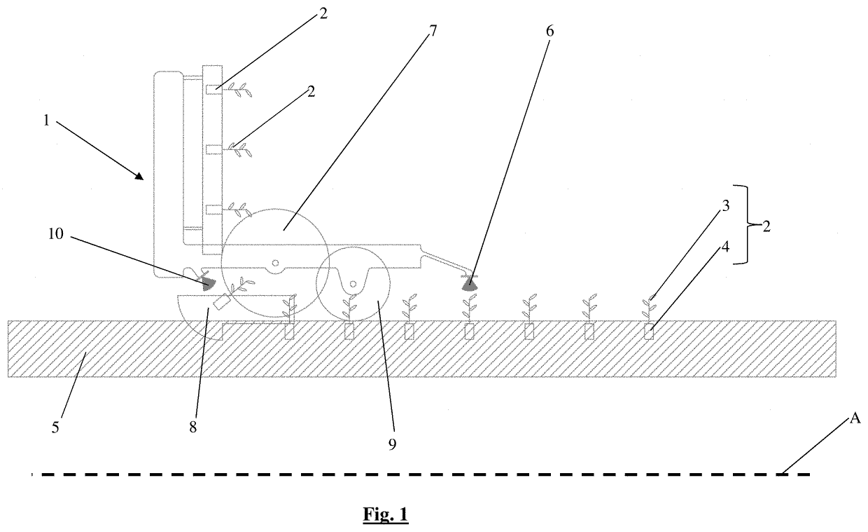

FIG. 1 is a simplified representation of a planting machine according to the invention while arranging seedlings in a field.

FIG. 1 shows one embodiment of a planting machine (1) according to the invention in a simplified manner while said planting machine is arranging plants (2), in this case seedlings (2), in a field (5).

Said planting machine (1) is provided for arranging plants (2), in this case seedlings (2), in a field (5). In this case, said seedlings (2) are formed by arranging a seed in a clod and allowing said seed to germinate into a seedling. In this case, the planting machine (1) is provided to arrange the seedlings (2) in such a way that the clod extends virtually all the way under the ground surface of the field (5) and a portion of the seedling extends above the ground surface of the field (5). After the seedlings (2) are arranged in the field (5), the seedlings (2) therefore always comprise an above-ground portion (3) that extends above ground and an underground portion (4) that extends underground.

The planting machine (1) comprises a first detection system for detecting the plants (2) after the plants (2) have been arranged in the field (5), said first detection system comprising an optical camera (6) for detecting said above-ground portions (3) of the plants (2). Said optical camera (6) is capable of detecting where the above-ground portion (3) is located but is also capable of detecting the height, the color, the number of leaves, the central stem of the seedlings (2), etc.

Furthermore, the planting machine (1) comprises an electronic device, the first detection system being provided for sending signals to the electronic device according to the detection of said above-ground portions (3) of the plants (2). The planting machine (1) also comprises a GPS system with which the GPS location of the optical camera (6) can be measured, and the GPS system is provided for sending signals to the electronic device according to the GPS location of the optical camera (6). The electronic device is provided for processing all of said signals and is thus capable of mapping the position of good plants (2) in the field (5). The above-ground portions (3) having a different color, a low height, too few leaves, etc. are not mapped because the probability of said seedling (2) growing into plants (2) that are suitable for harvesting is low.

The planting machine (1) further comprises a planting device (7) for physically arranging the plants (2) in the field (5). The planting machine (1) also comprises a furrow opener (8) for opening a furrow, and the planting device (7) is provided for arranging the seedlings (2) in said formed furrow. Furthermore, the planting machine (1) comprises a furrow closer (9) for closing the furrow again after the seedlings (2) have been arranged in the furrow. While the seedlings (2) are being arranged in a row, the planting machine (1) moves in a direction of travel (A). The optical camera (6) is located behind the furrow closer (9) as seen in the direction of travel (A). This is also easily visible in FIG. 1. The optical camera (6) is connected to the rear of the chassis of the planting machine (1) in such a way that the optical camera (6) extends at a certain distance from the chassis as seen in the direction of travel (A). As a result of this, there is a lot of light exposure at the level of the optical camera (6) such that said optical camera is well able to detect the above-ground portion (3).

The planting machine (1) additionally comprises a second detection system for detecting the plants (2) while the plants (2) are being arranged in the field (5) by the planting device (7). Said second detection system comprises an optical camera (10).

With the aid of said planting machine (1), the position of the good seedlings (2) in the field (5) is already mapped while the seedlings (2) are being planted in the field (5) by the planting machine (1). This information can be passed on to other agricultural machines, such as machines for hoeing, irrigating plants (2), fertilizing plants (2), harvesting plants (2), etc.

1. Planting machine for arranging plants, such as seedlings, in a field in such a way that, after being arranged in the field, the plants comprise an above-ground portion that extends above ground and an underground portion that extends underground, said planting machine comprising a detection system for detecting the plants after the plants have been arranged in the field, said detection system comprising at least one measuring instrument for detecting said above-ground portions of the plants, and the planting machine comprising or being capable of coupling to an electronic device, such as a central processing unit, the detection system being provided for sending signals to the electronic device according to the detection of said above-ground portions of the plants and the electronic device being provided for processing said signals, wherein the electronic device is provided for mapping the position of the plants in the field and this at least based on the signals coming from the detection system.

2. Planting machine according to claim 1, characterized in that the at least one measuring instrument comprises a sensor for measuring one or more biophysical properties of said above-ground portions of the plants.

3. Planting machine according to claim 1, characterized in that the planting machine comprises a GNSS system for correlating the signals coming from the detection system with the GNSS location.

4. Planting machine according to claim 3, characterized in that the GNSS system is provided for sending signals to the electronic device and in that the electronic device is provided for mapping the position of the plants in the field on the signals coming from the GNSS system and the signals coming from the detection system.

5. Planting machine according to claim 1, characterized in that the planting machine comprises a planting device for physically arranging the plants in the field and in that the electronic device is provided for contributing to the control of the planting device.

6. Planting machine according to claim 1, characterized in that the planting machine comprises a treatment system for treating the plants that are arranged in the field by the planting machine and in that the electronic device is provided for controlling this treatment system and this at least based on the signals coming from the detection system.

7. Planting machine according to claim 1, characterized in that the at least one measuring instrument comprises an optical sensor, such as a camera.

8. Planting machine according to claim 7, characterized in that the optical sensor is provided for detecting the position of a central part of said above-ground portions.

9. Planting machine according to claim 7, characterized in that the optical sensor is provided for detecting the height of said above-ground portions.

10. Planting machine according to claim 1, characterized in that the planting machine is provided for moving in a direction of travel while arranging the plants in the field and in that the planting machine comprises a planting device that is provided for physically arranging the plants in the field, the measuring instrument extending behind the planting device as seen in the direction of travel.

11. Planting machine according to claim 10, characterized in that the planting machine comprises one or more furrow openers for towing one or more furrows and in that the planting device is provided for arranging plants in the one or more furrows and in that the planting machine comprises one or more furrow closers for closing the one or more furrows again after the plants have been arranged in the one or more furrows and in that the measuring instrument extends behind the one or more furrow closers as seen in the direction of travel.

12. Planting machine according to claim 1, characterized in that the detection system comprises at least two of said measuring instruments for detecting said above-ground portions of the plants.

13. Planting machine according to claim 12, characterized in that the planting machine is provided for moving in a direction of travel while arranging the plants in the field and in that said at least two measuring instruments extend at a distance from each other as seen in said direction of travel.

14. Planting machine according to claim 1, characterized in that the planting machine comprises a detection system for detecting properties of the field.

15. Planting machine according to claim 1, characterized in that the planting machine comprises a detection system for detecting the plants prior to or while arranging the plants.

16. Method for mapping the position of plants in a field, characterized in that the plants, such as seedlings, are arranged in the field with the aid of a planting machine according to claim 1, and while the plants are being arranged in the field, the position of the plants in the field is mapped according to the detection of said above-ground portions of the plants by the respective detection system.
